(19) United States
(12) Patent Application Publication
(10) Pub. No.: US 2014/0041671 A1
(43) Pub. Date: Feb. 13, 2014

(54) REFILL FILTERING FACE-PIECE RESPIRATOR

(71) Applicants: Niraj Kumar, Karnataka (IN); Thiyagarajan Kuppuswami, Bangalore (IN); Abhijeet A. Saungikar, Bangalore (IN)

(72) Inventors: Niraj Kumar, Karnataka (IN); Thiyagarajan Kuppuswami, Bangalore (IN); Abhijeet A. Saungikar, Bangalore (IN)

(73) Assignee: 3M Innovative Properties Company

(21) Appl. No.: 13/571,451

(22) Filed: Aug. 10, 2012

(51) Int. Cl. A41D 13/11; B23P 11/00

(52) U.S. Cl. 128/863; 29/428

(57) ABSTRACT

A filtering face-piece respirator 10 that includes a reusable harness 19, a reusable frame 16, and a replaceable filtering structure 18. The reuseable frame 16 has the reusable harness 14 secured to it and has first and second opposing panels 28a, 28b that define a slot 38 into which the replaceable filtering structure 18 can be manually inserted to be joined to the reusable frame 16 in a removable fashion. The replaceable filtering structure 18 also is able to be separated from the reusable frame 16 by being manually withdrawn from the slot 38. The respirator provides a convenient method for reusing all respirator ports but the filtering structure while protecting the reusable parts from exposure to contaminants.

### BACKGROUND

Filtering face-piece respirators have become a popular device for protecting persons from inhaling contaminants that are present in the ambient environment. These respirators are worn over the wearer's nose and mouth to separate contaminated ambient air from the mask interior where clean air is present. During use, essentially the whole mask body is available to filter air that passes through it. Because filtering face-piece respirators are light in weight and are very efficient at filtering air, they are used by many industries, including construction, manufacturing, auto painting and repair, pharmaceutical preparation, surgery, and the like.

Filtering face-piece respirators generally fall into one of two categories, namely, flat-fold respirators and shaped respirators. Flat-fold respirators are stored flat but include seams, pleats, and/or folds that allow the mask to be opened into a cup-shaped configuration for use. Examples of flat-fold filtering face-piece respirators are shown in U.S. Pat. Nos. 6,568,392 and 6,484,722 to Bostock et al. and 6,394,090 to Chen. Shaped respirators, in contrast, are more-or-less permanently formed into a desired face-fitting configuration and generally retain that configuration during storage and use. Examples of patents that disclose shaping layers for supporting filtration layers include U.S. Pat. Nos. 7,131,442 to Kronzer et al., 4,850,347 to Skov, 4,807,619 to Dyrud et al., and 4,536,440 to Berg.

Filtering face-piece respirators typically are constructed to have the filter media as an integral part of the mask body. As such the filter media cannot be replaced from the mask body without destroying much of the respirator. To preserve the useful parts of the respirator once the filter media has met the end of its service life, respirators therefore have been designed, which have replaceable filter cartridges or replaceable filter media attached to or included in the mask body—see U.S. Pat. Nos. 6,277,178 to Holmquist-Brown et al., 3,521,630 to Westberg, Japanese Patent 2005-304,635, and Korean application 2008-0088708. Investigators in the respirator art have not, however, produced filtering face-piece respirators where the filtering structure is inserted within a reusable frame where it can be readily attached thereto and removed therefrom. Known filtering face-piece respirators also have not been provided with a replaceable filtering structure that covers reusable portions of the respirator to keep them clean for further usage. Conventional respirators that use replaceable filters generally have used a molded mask body that has a replaceable filter cartridge. The molded mask body, which is reused, touches the wearer's face during use and therefore should be cleaned and sanitized after each use.

### SUMMARY OF THE INVENTION

The present invention provides a flat-fold filtering face-piece respirator that comprises a reusable harness, a replaceable filtering structure, and a reusable frame. The reuseable frame has the reusable harness secured thereto and comprises first and second opposing panels that define a slot into which the replaceable filtering structure can be manually inserted to be joined to the reusable frame in a removable fashion. This assembly provides a flat-folded mask body that can be opened into a cup-shaped configuration for placement over a person's nose and mouth when used for filtering contaminants. The present invention also provides a new method of making a respirator, which method comprises: inserting a replaceable filtering structure into a slot of a reusable frame; and securing a flap of the filtering structure to an outer surface of a panel on frame. The replaceable filtering structure also is able to be manually separated from the reusable frame by being withdrawn from the slot. This ability to manually separate allows the spent filtering structure to be easily replaced so that the mask body can be refilled with a fresh filtering structure. The present invention therefore is beneficial in that it reduces overall cost of respiratory protection for an organization that has workers who need to wear multiple respirators. The components, that is, the nose clip, elastic headband, and support structure, which are otherwise discarded, can be reused with a new filtering structure. The invention also is ecologically advantageous in that overall waste generation is less. The inventive refill respirator therefore is convenient to use, has few parts, is light in weight, allows for easy filter replacement, and provides cost and environmental benefits.

### GLOSSARY

The terms set forth below will have the meanings as defined:

“comprises (or comprising)” means its definition as is standard in patent terminology, being an open-ended term that is generally synonymous with “includes”, “having”, or “containing” Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive respirator in serving its intended function;

“clean air” means a volume of atmospheric ambient air that has been filtered to remove contaminants;

“coextensively” means extending parallel to;

“contaminants” means particles (including dusts, mists, and fumes) and/or other substances that generally may not be considered to be particles (e.g., organic vapors, et cetera) but which may be suspended in air, including air in an exhale flow stream;

“cover web” means a nonwoven fibrous layer that is not primarily designed for filtering contaminants or that is not the primary filtering layer;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges, filter liners, or insert-molded filter elements attached to or molded into a non-fluid permeable mask body;

“air filter”, “filtration layer”, or “primary filtering layer” means one or more layers of air-permeable material, which layer(s) is adapted for the primary purpose of removing contaminants (such as particles) from an air stream that passes through it;

“filtering structure” means a construction that is designed primarily for filtering air and that contains a filtration layer;

“flat-fold” means designed to have the ability to be placed or folded into a generally flat configuration for non-use;

“frame” means a structure that has an opening to allow for the attachment of, and that gives support to, a filtering structure;

“harness” means a structure or combination of parts that assists in supporting the mask body on a wearer's face;

“integral” means that the parts in question cannot be separated without compromising or destroying the structure as a whole;

“juxtaposed” or “juxtapositioned” means having the major surfaces at least in contact with each other;

“interior gas space” means the space between a mask body and a person's face;

“mask body” means a structure or combination of parts that is designed to fit over the nose and mouth of a person, that filters air that passes through it, and that helps define an interior gas space separated from an exterior gas space;

“microfiber” means fibers having an effective fiber diameter of 1 to 20 micrometers;

“nose clip” means a mechanical device (other than a nose foam), which device is adapted for use on a mask body to improve the seal at least around a wearer's nose;

“nonwoven” means a structure or portion of a structure in which the fibers are held together by a means other than weaving;

“panel” means a part that can be placed in a generally flat configuration;

“parallel” means being generally equidistant;

“perimeter” means the outer edge of the mask body, which outer edge would be disposed generally proximate to a wearer's face when the respirator is being donned by a person;

“porous” means air-permeable;

“polymer” means a material that contains repeating chemical units, regularly or irregularly arranged;

“polymeric” and “plastic” each mean a material that mainly includes one or more polymers and may contain other ingredients as well;

“plurality” means two or more;

“removable” means capable of being physically separated through manual means;

“replaceable” means capable of being manually removed so that another part of the same configuration can be put in the same location;

“respirator” means an air filtration device that is worn by a person on the face over the nose and mouth to provide clean air for the wearer to breathe;

“reusable frame” means a frame that can be used again with another filtering structure;

“reusable harness” means a harness that can be used again with another filtering structure;

“slot” means an elongated gap between two parts;

“solidity” means the percent solids in a web;

“staple fiber” means fibers having a determinate length;

“thermally bonding (or bondable) fibers” mean fibers that bond to adjacent plastic items after being heated above their melting point and subsequently cooled;

“upstream” means located before at a point in time in moving fluid stream; and

“web” means a structure that is significantly larger in two dimensions than in a third and that is air permeable.

### BRIEF DESCRIPTION OF THE DRAWINGS

FIG. 1 is a perspective view of a flat-fold filtering face-piece respirator 10, in accordance with the present invention, in an open in-use condition on a person's face;

FIG. 2 is a top view of the flat-fold filtering face-piece respirator 10 of FIG. 1, showing the replaceable filtering structure 18 separate from the reusable frame 16 and the reusable harness 18;

FIG. 3 is a front view of the replaceable filtering structure 18 separate from the reusable frame 16 and the reusable harness 14;

FIG. 4 is a top view of the replaceable filtering structure 18 being inserted into the reusable frame 16;

FIG. 5 is a top view of the assembled filtering face-piece respirator 10 in a folded condition;

FIG. 6 is a front view of the replaceable filtering structure 18, showing the replaceable filtering structure 18 being separated from the reusable frame 16; and

FIG. 7 is a cross section of a filtering structure 18 that may be used in connection with a respirator 10 of the present invention.

### DETAILED DESCRIPTION OF PREFERRED EMBODIMENTS

In the practice of the present invention, a flat-fold filtering face-piece respirator is provided which comprises a reusable harness, a replaceable filtering structure, and a reusable frame. The frame has the reusable harness secured thereto and comprises first and second opposing panels that define a slot into which the replaceable filtering structure can be manually inserted to be joined to the reusable frame in a removable fashion to provide a flat-folded mask body that can be opened into a cup-shaped configuration for placement over a person's nose and mouth when in use. The replaceable filtering structure also is able to be separated from the reusable frame by being manually withdrawn from the slot.

The reusable frame may comprise a substantially large insertion opening or slot that allows the user to easily insert and align the filtering structure to the reusable frame. The replaceable filtering structure may include filter media that is sandwiched between two cover-webs, one of which may comprise material that has complimentary property to the outer material of the reusable frame to enable a leak proof assembly to be created. The replaceable filtering structure is easily inserted into the refillable frame, which may comprises a 3M micro replicating sheet backed by flexible and abiding surface that facilitates easy insertion of the filtering structure into the slot. The frame has a headband attached to it, and it may also have an adjustable nose clip disposed between two layers. The refill filtering face-piece respirator is characterized by an economy of components/structure, ease of assembly, and protection of reusable components exposure to contaminants.

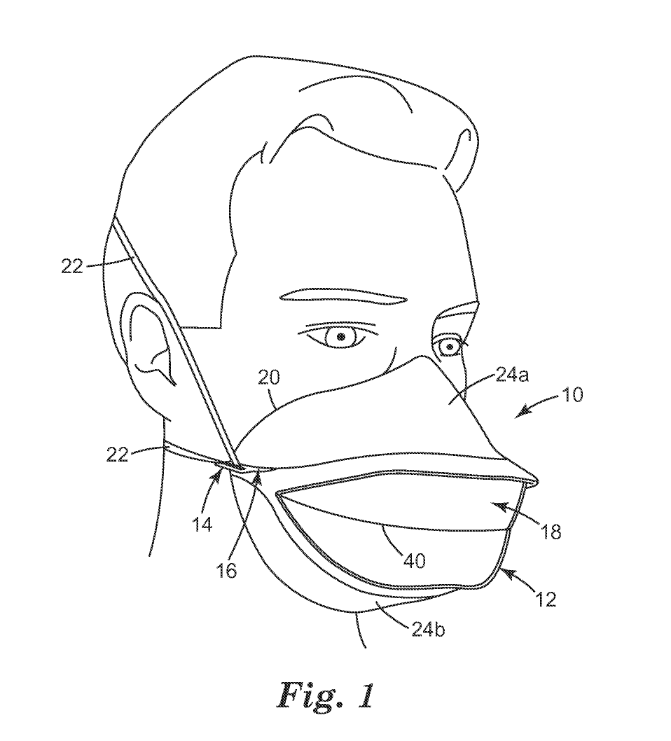

FIG. 1 shows an example of a flat-fold filtering face-piece respirator 10 that may be used in accordance with the present invention to provide clean air for a wearer to breathe. The filtering face-piece respirator 10 includes a mask body 12 and a reusable harness 14. The mask body 12 has a reusable frame 16 that provides structural integrity to the mask body and that provides support for a replaceable filtering structure 18 that attaches it. The filtering structure 18 removes contaminants from the ambient air when a wearer of the respirator 10 inhales. The filtering structure 18 may be secured to the reusable frame 16 at the mask body perimeter 20. The attachment of the filtering structure 18 to the frame 16 at the perimeter 20 may be achieved through a variety of mechanical means as described below. The replaceable filtering structure 18 in the mask body 12 may have an outer cover web that comprises a nonwoven web of melt-blown fibers, spun bond fibers, and/or staple fibers. The web of fibers can be mechanically fastened to an outer surface of the frame 16. The reusable harness 14 may include one or more straps 22 that enable the mask body 12 to be supported over the wearer's nose and mouth. Adjustable buckles may be provided on the reusable harness 14 to allow the straps 22 to be adjusted in length. Fastening or clasping mechanisms also may be attached to the straps 22 to allow the harness 14 to be disassembled when removing the respirator 10 from the wearer's face and reassembled when donning the respirator 10 onto a person's face.

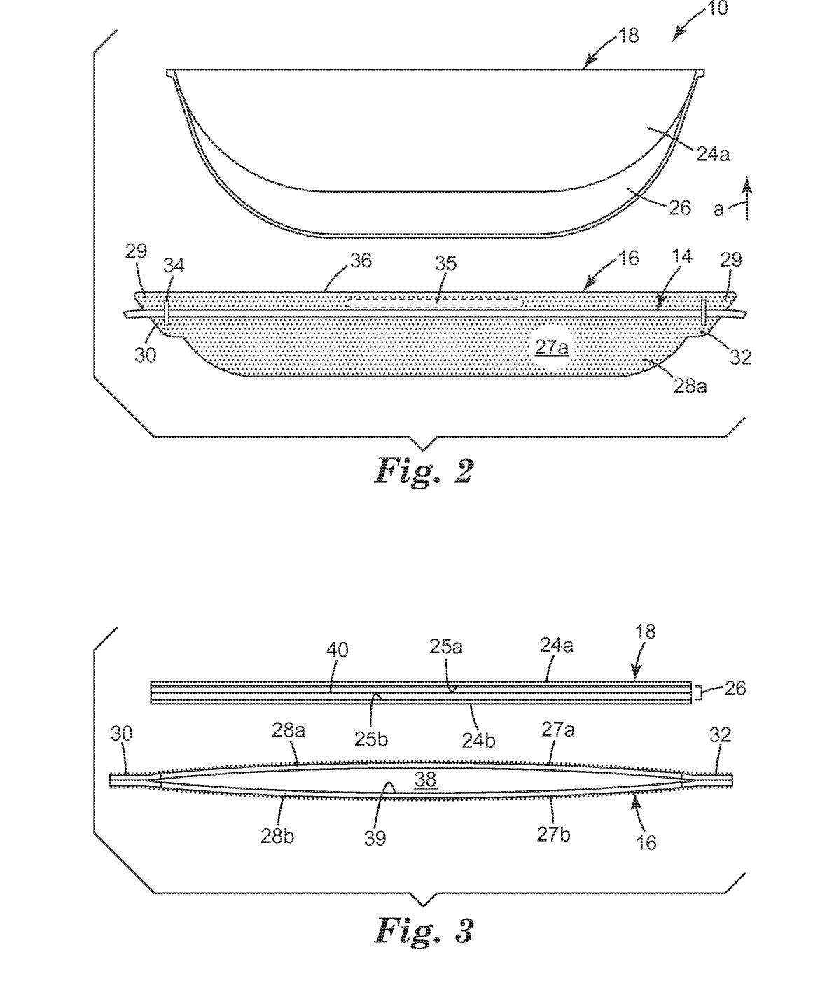

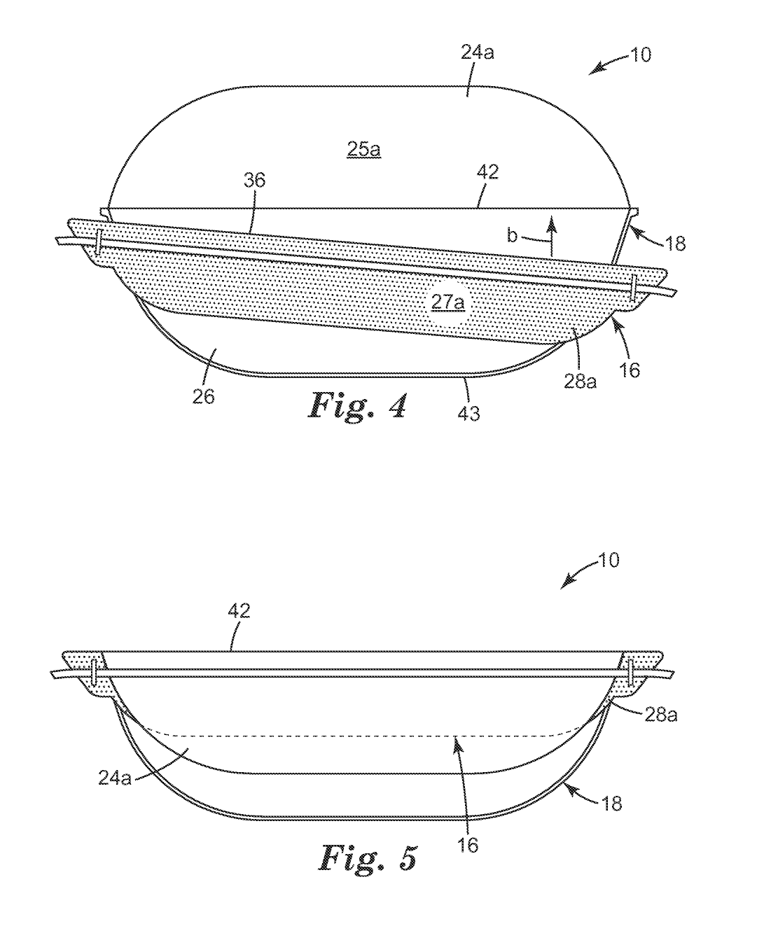

FIG. 2 shows the respirator 10 in two-part form where the replaceable filtering structure 18 is separated from the frame 16. The replaceable filtering structure 18 includes a first flap 24a and a fluid permeable main portion 26. The first flap 24a may or may not be fluid permeable, but the main portion is permeable to air to enable ambient air drawn therethrough to be filtered. When the filtering structure 18 is joined to the frame 16 as an assembled unit or respirator 10 (FIGS. 1 and 5), the flap 24a resides outside of the frame 16 where it does not play a role in removing contaminants from the ambient air when a wearer inhales. The inside surface 25a (FIGS. 3 and 4) of the first flap 24a may be provided with a fibrous surface that mechanically adheres to the outer surface or layer 27a of a first panel 28a on the frame 16. The frame 16 may have the harness 14 joined to it at tabs 29 located at first and second ends 30 and 32, respectively. The strap(s) 22 that comprise the harness 14 may be secured to the ends 30 and 32 of the frame 16 by any suitable mechanical or physical attachment means such as staples 34. Alternatively, the strap(s) 22 may be adhesively bonded or welded to the frame 16. An example of another attachment means is the retention assembly and compression element described in U.S. Pat. No. 6,729,332 to Castiglione. The frame 16 also may include a nose clip 35 that is located centrally on the frame 16 adjacent to the edge 36, which edge 36 would reside in close proximity to the wearer's face when the assembled respirator 10 is being donned. The manually-adaptable nose clip 35 enables the respirator 10 to form a snug fit over the wearer's nose so that there is not leakage in that location when a wearer inhales. The nose clip 35 may be located on the outer surface or layer 27a of the first panel 28a, or it may be located beneath the outer layer 27a of the panel 28a.

FIG. 3 also shows the frame 16 separate from the filtering structure 18. In this view, however, the frame 16 and filtering structure 18 are each shown from the front (direction of arrow a, FIG. 2) rather than from the top as illustrated in FIG. 2. The reusable frame 16 includes first and second panels 28a and 28b, and the filtering structure includes first and second flaps 24a and 24b. The first and second panels 28a, 28b are joined together at the first and second ends 30, 32 of frame 16. These panels 28a, 28b and the joined ends 30, 32 define a slot 38 through which the filtering structure 18 may be inserted. The flaps 24a, 24b may comprise a nonwoven web of fibers. The outer layer 27a, 27b on panels 28a, 28b may includes a hook type material that can engage the fibrous material located on the inside surfaces 25a, 25b of the respective flaps 24a, 24b. The panels 28a, 28b also may contain an inner layer 39 that may be a smooth fabric located on the inside surface of the panels 28a, 28b that comprise the frame 16. The smooth fabric enables the filtering structure 18 to be easily drawn into or removed from a slot 38 in the frame 16. The filtering structure 18 may include one or more filter media layers to remove contaminants that are present in the ambient air. In addition, the filtering structure 18 may have one or more pleats 40 (FIG. 1) in the filtering portion 26 to enable the mask body 12 to be expanded when placed in an unfolded condition for on-the-face use.

FIG. 4 shows how the inventive respirator 10 may be assembled from the frame 16 and the filtering structure 18. The fluid-permeable filtering portion 26 of the filtering structure 18 is placed within the slot 38 (FIG. 3) of the frame 16. The panels 28a, 28b (FIG. 3) are slightly separated so that the fluid-permeable filtering portion 26 of the filtering structure 18 can be slid therebetween, causing the frame 16 to move in the direction of arrow b relative to the filtering structure 18. The two parts 16, 18 of the respirator 10 are moved relative to one another until the perimeter edge 36 of the frame 16 is parallel to and in line with the perimeter fold and/or weld line 42 where the flap 24a meets the filtering portion 26 of the filtering structure 18. The filtering portion 26 extends forward from perimeter line 42 to the opposing edge 43 of the filtering structure 18. Once edge 36 is so positioned relative to fold line 42, the flap 24a may be folded over to be juxtapositioned coextensively against the outer surface 27a of the first panel 28a as shown in FIG. 5. The inside surface of the flap 24a may be provided with a means that enables the flap 24a to be secured to the frame panel 28a. Such a securement means may include the fibrous nature of a cover web that is included on the filtering structure 18. The nonwoven fibrous cover web may become joined to a textured surface that includes a multitude of hooks that mechanically mate with the nonwoven material on the inside surface 25a of the flap 24a—see, for example, U.S. Pat. No. 6,054,091 to Miller et al. In lieu of a hook and loop type mechanical fastener, the flaps 24a and 24b may be provided with an adhesive that is capable of allowing the inside surface 25a, 25b of the flaps 24a, 24b to be adhered to the outer surface 27 of the respective panels 28a, 28b (FIG. 3). A release liner may be placed over the adhesive material so that it does not prematurely stick to another surface. An example of an adhesive type system that may be used in connection with the present invention is described in one or more of the following publications: U.S. Pat. Nos. 5,629,063 and 5,571,586 to Gobran, 5,300,057 to Miller et al., 5,066,289 to Polski and US 2009/202772 to Vanderzanden et al.

FIG. 5 shows that the flaps may cover a substantial portion, if not all, of the outer surface of the panels. When folded about the perimeter line 42 and pressed against the outer surface of the frame panel 28a, the flap 24a becomes removably secured thereto and protects the reusable frame 16 from exposure to contaminants that may be present in the ambient environment. The folded mask 10 may be opened into a cup-shaped configuration for placement over a person's nose and mouth as shown in FIG. 1.

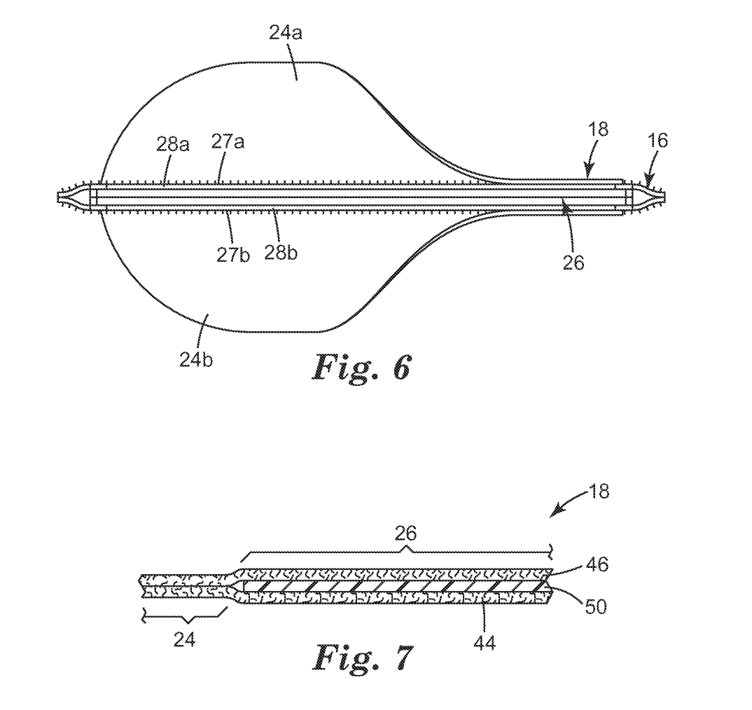

FIG. 6 shows how the replaceable filtering structure 18 may be separated from the reusable frame 16 when the wearer desires to refill the respirator with a new filtering structure. To do so, the flaps 24a, 24b can be manually separated from the panels 28a, 28b by peeling the flaps 24a, 24b away from the outer surface 27a, 27b of panels 28a, 28b. Once the flaps 24a, 24b of the filtering structure 18 are fully separated from the panels 28a, 28b of the frame 16, the filtering portion 26 of the filtering structure 18 can be slid from the slot 38 (FIG. 3) so that another filtering structure can be inserted into the same slot to be secured to the frame 16. The replaceable filtering structure may exhibit a Locking Mechanism Strength of at least 0.08 kilograms force (kgf), more typically 0.1 kgf, and still more typically at least 0.2 kgf. At the upper end, the Locking Mechanism Strength typically is less than 0.25 kgf. Locking Mechanism Strength may be determined using the Locking Mechanism Strength Test described below.

FIG. 7 shows that the filtering structure 18 may include one or more cover webs 44 and 46 and a filtration layer 50. The cover webs 44 and 46 may be located on opposing sides of the filtration layer 50 to capture any fibers that may come loose therefrom. Typically, the inner cover web 44 may be made from a fiber selection that provides a comfortable feel on the side of the filtering structure 18 that makes contact with the wearer's face. The combination of cover webs 44, 46 and filtering layers 50 may be located throughout the filtering portion 26 of the filtering structure 18. The cover webs 44, 46 may extend from the end of the filtering portion 26 of the filtering structure 18 to define the flaps 24 (24a or 24b) that joins the filtering structure 18 to the frame 16. The filtration layer 50 of the filtering structure 18 need not extend into the flap part 24 of the filtering structure 18 when the frame panels 28a, 28b (FIG. 3) are not fluid permeable.

### The Cover Webs:

The cover web can be used to entrap fibers that may come loose from the filtering layer and to protect the frame panels from exposure to contaminants. The cover web typically does not provide any substantial filtering benefits to the filtering structure, although it can act as a pre-filter when disposed on the exterior of (or upstream to) the filtration layer. The cover web preferably has a comparatively low basis weight and is formed from comparatively fine fibers. More particularly, the cover web may be fashioned to have a basis weight of about 5 to 50 g/m² (typically 10 to 30 g/m²), and the fibers may be less than 3.5 denier (typically less than 2 denier, and more typically less than 1 denier but greater than 0.1 denier). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web may be blown microfiber (BMF) materials, particularly polyolefin BMF materials, for example polypropylene BMF materials (including polypropylene blends and also blends of polypropylene and polyethylene). Cover webs can be made by introducing the loose cover web fibers into the forming chamber as described above. Alternatively, a cover web can be pre-made as described in U.S. Pat. No. 4,013,816 to Sabee et al. In the latter instance, the pre-made web may be formed by collecting the fibers on a smooth surface, typically a smooth-surfaced drum or a rotating collector—see U.S. Pat. No. 6,492,286 to Berrigan et al. Spun-bond fibers also may be used as loose fibers in assembling cover webs according to the invention.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J. W. Suominen O Y of Nakila, Finland.

Cover webs that are used in the invention generally have very few fibers protruding from the web surface after processing and therefore provide a smooth outer surface—see in U.S. Pat. Nos. 6,041,782 to Angadjivand, U.S. Pat. No. 6,123,077 to Bostock et al., and WO 96/28216A to Bostock et al.

The cover web may contain other fibers such as staple fibers that are distributed throughout and intermingled within a network of melt-blown fibers. Staple fibers are typically added to a nonwoven web in solidified form. Often, they are made by processes such that the fiber diameter more closely resembles the size of the orifice through which the fiber is extruded. Regardless of their process of manufacture or composition, staple fibers are typically machine cut to a specific predetermined or identifiable length. The length of the staple fibers typically is much less than that of melt-blown fibers, and may be less than 0.6 meters, or less than about 0.3 meters. The staple fibers may have a length of about 1 to 8 centimeters (cm), more typically about 2.5 cm to 6 cm. The average geometric fiber diameter for the staple fibers is generally greater than about 15 μm on average, and in various embodiments can be greater than 20, 30, 40, or 50 μm. The staple fibers generally have a denier of greater than about 3 grams per 9000 meters (g/9,000 m), and equal to or greater than about 4 g/9,000 m. At the upper limit, the denier is typically less than about 50 g/9,000 m and more commonly is less than about 20 g/9000 m to 15 g/9000 m. The outer cover web may comprise at least about 10 weight % staple fibers and 90 weight % melt-blown fibers. Suitable staple fibers may be prepared from polyethylene terephthalate, polyester, polyethylene, polypropylene, copolyester, polyamide, or combinations of one of the foregoing. The staple fibers may be crimped fibers like the fibers described in U.S. Pat. No. 4,118,531 to Hauser. Crimped fibers may have a continuous wavy, curly, or jagged profile along their length. The staple fibers may comprise crimped fibers that comprise about 10 to 30 crimps per cm. The staple fibers may be single component fibers or multi-component fibers.

Melt-blown fibers may be prepared by a melt-blowing process as described in, for example, U.S. Pat. No. 4,215,682 to Kubik et al. Typically, melt-blown fibers are very long in comparison to staple fibers. Unlike staple fibers, which typically have a specific or identifiable length, melt-blown fibers typically have an indeterminate length. Although melt-blown fibers are sometimes reported to be discontinuous, the fibers generally are long and entangled sufficiently that it is usually not possible to remove one complete melt-blown fiber from a mass of such fibers or to trace one melt-blown fiber from beginning to end. In addition, the diameter of a solidified melt-blown fiber may differ significantly from (e.g., be much smaller than) the size of a source orifice from which the molten fiber precursor was produced. To provide an outer cover web that acts as a prefilter, upstream to the primary filtering layer, the melt-blown fibers in the outer cover web may be electrically-charged using, for example, the method described in the '682 Kubik et al. patent. Alternatively, corona charging and hydrocharging methods may be used, as described below in the section pertaining to the filter layer, to charge the fibers in one or more of the outer cover webs.

### The Filtering Layer(s):

Filter layers used in the filtering structure of the invention can be of a particle capture or gas and vapor type. The filter layer also may be a barrier layer that prevents the transfer of liquid from one side of the filter layer to another to prevent, for instance, liquid aerosols or liquid splashes from penetrating the filter layer. Multiple layers of similar or dissimilar filter types may be used to construct the filtration layer of the invention as the application requires. Filter layers beneficially employed in the mask body of the invention are generally low in pressure drop, for example, less than about 20 to 30 mm H₂O at a face velocity of 13.8 centimeters per second to minimize the breathing work of the mask wearer. Filtration layers additionally are commonly flexible and have sufficient structural integrity so that they do not come apart under expected use conditions. Examples of particle capture filters include one or more webs of fine inorganic fibers (such as fiberglass) or polymeric synthetic fibers. Synthetic fiber webs may include electret charged polymeric microfibers that are produced from processes such as melt-blowing. Polyolefin microfibers formed from polypropylene that are surface fluorinated and electret charged, to produce non-polarized trapped charges, provide particular utility for particulate capture applications. An alternate filter layer may comprise a sorbent component for removing hazardous or odorous gases from the breathing air. Absorbents and/or adsorbents may include powders or granules that are bound in a filter layer by adhesives, binders, or fibrous structures—see U.S. Pat. No. 3,971,373 to Braun. Sorbent materials such as activated carbons, that are chemically treated or not, porous alumna-silica catalyst substrates, and alumna particles are examples of sorbents useful in applications of the invention. U.S. Pat. Nos. 7,309,513 and 7,004,990 to Brey et al., and 5,344,626 to Abler disclose examples of activated carbon that may be suitable.

The filtration layer is typically chosen to achieve a desired filtering effect and, generally, removes a high percentage of particles or other contaminants from the gaseous stream that passes through it. For fibrous filter layers, the fibers selected depend upon the kind of substance to be filtered and, typically, are chosen so that they do not become bonded together during the molding operation. As indicated, the filter layer may come in a variety of shapes and forms. It typically has a thickness of about 0.2 millimeters (mm) to 1 centimeter (cm), more typically about 0.3 mm to 1 cm, and it could be a corrugated web that has an expanded surface area relative to the shaping layer—see, for example, U.S. Pat. Nos. 5,804,295 and 5,656,368 to Braun et al. The filtration layer also may include multiple layers of filter media joined together by an adhesive component—see U.S. Pat. No. 6,923,182 to Angadjivand et al.

Essentially any suitable material that is known (or later developed) for forming a filtering layer may be used as the filtering material. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Melt-blown webs may be made using the apparatus and die described in U.S. Pat. Nos. 7,690,902, 6,861,025, 6,846,450, and 6,824,733 to Erickson et al. Electrically charged fibrillated-film fibers as taught in van Turnhout, U.S. Patent RE 31,285, also may be suitable, as well as rosin-wool fibrous webs and webs of glass fibers or solution-blown, or electrostatically sprayed fibers, especially in microfiber form. Nanofiber webs also may be used as a filtering layer—see U.S. Pat. No. 7,691,168 to Fox et al. Electric charge can be imparted to the fibers by contacting the fibers with water as disclosed in U.S. Pat. Nos. 7,765,698 to Sebastian et al., 6,824,718 to Eitzman et al., 6,783,574 to Angadjivand et al., 6,743,464 to Insley et al., 6,454,986 and 6,406,657 to Eitzman et al., and 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the fiber surfaces in the filter layer to improve filtration performance in an oily mist environment—see U.S. Pat. Nos. 5,025,052 and 5,099,026 to Crater et al.; U.S. Pat. Nos. 6,398,847 B1, 6,397,458 B1, and 6,409,806 B1 to Jones et al.; U.S. Pat. No. 7,244,292 to Kirk et al.; and U.S. Pat. No. 7,244,291 to Spartz et al. Typical basis weights for electret BMF filtration layers are about 10 to 100 grams per square meter (g/m²). When electrically charged and optionally fluorinated as mentioned above, the basis weight may be about 30 to 200 g/m² and about 40 to 80 g/m², respectively.

### Respirator Components:

The strap(s) that are used in the harness may be made from a variety of materials, such as thermoset rubbers, thermoplastic elastomers, braided or knitted yarn/rubber combinations, inelastic braided components, and the like. The strap(s) may be made from an elastic material such as an elastic braided material. The strap preferably can be expanded to greater than twice its total length and be returned to its relaxed state. The strap(s) also could possibly be increased to three or four times its relaxed state length and can be returned to its original condition without any damage thereto when the tensile forces are removed. The elastic limit thus is generally not less than two, three, or four times the length of the strap when in its relaxed state. Typically, the strap(s) are about 20 to 30 cm long, 3 to 10 mm wide, and about 0.9 to 1.5 mm thick. An example of a strap that may be used in connection with the present invention is described in U.S. Pat. No. 6,332,465 to Xue et al. Examples of a fastening or clasping mechanism that may be used to joint one or more parts of the strap together is shown, for example, in the following U.S. Pat. Nos. 6,062,221 to Brostrom et al., 5,237,986 to Seppala, and EP1,495,785A1 to Chien and in U.S. Patent Publication 2009/0193628A1 to Gebrewold et al. and International Publication WO2009/038956A2 to Stepan et al.

An exhalation valve may be attached to the mask body to facilitate purging exhaled air from the interior gas space. An exhalation valve may improve wearer comfort by rapidly removing the warm moist exhaled air from the mask interior. See, for example, U.S. Pat. Nos. 7,188,622, 7,028,689, and 7,013,895 to Martin et al.; 7,493,900, 7,428,903, 7,311,104, 7,117,868, 6,854,463, 6,843,248, and 5,325,892 to Japuntich et al.; 7,849,856 and 6,883,518 to Mittelstadt et al.; RE37,974 and RE43,289 to Bowers. Essentially any exhalation valve that provides a suitable pressure drop and that can be properly secured to the mask body may be used in connection with the present invention to rapidly deliver exhaled air from the interior gas space to the exterior gas space. The exhalation valve may be attached to the mask body using, for example, the techniques described in U.S. Pat. No. 7,069,931 to Curran et al. or in U.S. Pat. No. 6,125,849 to Williams et al.

To improve fit and wearer comfort, an elastomeric face seal can be secured to the perimeter of the filtering structure. Such a face seal may extend radially inward to contact the wearer's face when the respirator is 31 being donned. Examples of face seals are described in U.S. Pat. Nos. 6,568,392 to Bostock et al., 5,617,849 to Springett et al., and 4,600,002 to Maryyanek et al., and in Canadian Patent 1,296,487 to Yard.

The nose clip that is attached to the reuseable frame may take the form of a strip of malleable metal such as aluminum. Examples of suitable nose clips are shown and described in U.S. Pat. Nos. 5,558,089 and Des. 412,573 to Castiglione, and U.S. Pat. No. 8,066,066 to Daugaard et al.—see also U.S. Patent application 2007/0068529A1 to Kalatoor.

### EXAMPLE

### Locking Mechanism Strength and Peel Strength

Locking Mechanism Strength was measured between the filtering structure and frame, with the flap material of the filtering structure fully engaged with the fastener component of the frame. Testing was done in accordance with ASTM D3330 (2010), 180 degree peel strength procedure. An Instron 33R 4467 Universal Testing Instrument was used to conduct the test. The filtering structure cover web was attached to the surface of the fastener structure on the frame panel, with one edge of fastener structure attached on the top jaw of the instrument and an edge of cover web attached on the bottom jaw of the instrument so that the joined panel of filtering structure cover web and fastener made an 180 deg angle at their peeling point. Sample width and length were 25.5 millimeters (mm) and 150 mm, respectively, cross head speed and gauge length were 300 mm/min and 40 mm, respectively. The Peel Strength was measured under ASTM D638. When measuring Peel Strength, the flap and frame are pulled parallel to each other in opposite directions. The objective of measuring the Locking Mechanism Strength was to know the force require to detach the frame from the flap when both jaws were moved at constant speed where the angle at the detach point was 180 degrees. The objective of measuring the Peel Strength was to know the force require to detach the frame from the flap when both jaws were moved at constant speed where the angle at the detach point is 0 degrees. The layers of material were drawn apart, and the maximum Locking Mechanism Strength and Peel Strength force were recorded in kilogram-force (kgf).

### Fit Test

Fit testing was conducted on a respirator in accordance the fit testing procedure outlined in 29 CFR 1910.134 (N95). A PORTACOUNT Respirator Fit Tester, model 8030, and a sodium chloride aerosol generator, model 8026, both from TSI Incorporated, Shoreview, Minn., U.S.A were used to evaluate fit. Fit factor is given in a numerical range where the numeral 40 represents passing and numeral 200 represents the maximum or best fit.

### Mask Reusability Test

Mask reusability was evaluated using a mannequin head with a face form to replicate work conditions encountered in multiple donnings and doffings of a mask. The effect of a series of donnings and doffings was evaluated by conducting fit test on an individual. The reusability protocol was conducted over a period of fifteen days. During the fifteen day period, a mask would be mounted on a mannequin head for a total of eight hours. During this time period, the mask would be donned and doffed four times to simulate likely workplace usage. At the end of a simulated work day, the respirator was worn by an individual, and fit testing was conduced according with the Fit Test procedure outlined above. During the donning step, the nose clip of mask's reusable frame was straightened and then re-bent to fit the face of the mannequin, this was done to replicate what a wearer might be required to do in reusing the mask. Test results were reported at days one, five, and fifteen.

Mask reusability was evaluated using a mannequin head with a face form to replicate work conditions encountered in multiple donnings and doffings of a mask. The effect of a series of donnings and doffings was evaluated by conducting fit test on an individual. The reusability protocol was conducted over a period of fifteen days. During the fifteen day period, a mask would be mounted on a mannequin head for a total of eight hours. During this time period, the mask would be donned and doffed four times to simulate likely workplace usage. At the end of a simulated work day, the respirator was worn by an individual, and fit testing was conduced according with the Fit Test procedure outlined above. During the donning step, the nose clip of mask's reusable frame was straightened and then re-bent to fit the face of the mannequin, this was done to replicate what a wearer might be required to do in reusing the mask. Test results were reported at days one, five, and fifteen.

### Example 1

A flat-fold filtering face piece respirator of the invention was assembled using two elements: a reusable frame and harness assembly, and a replaceable filtering structure. The reusable frame and harness assembly was made by first forming the frame elements. Frame elements were formed from two panels of material that were secured at their ends by ultrasonic welding. As is depicted generally in FIG. 2, staples 34 were used to secure the harness of the mask to the frame. A first frame element was constructed by layering a 24 centimeter (cm) by 4 cm section of cover web and a mechanical fastener sheet of the same size, the hooks of the mechanical fastener facing out. The cover web was a needle punched and calendered polyester nonwoven that had a basis weight 150 grams per square meter (gsm). The mechanical fastener was made of polypropylene and comprised of a flat film having an array of small hooks intended to mate against and hold a variety of different nonwoven materials. The layered sections of inner web and mechanical fastener were then ultrasonically welded together around their perimeter in a shape as is generally shown in FIG. 2, the shape having the tabs 29. Welding was done using a plunge type ultrasonic welder that had a 2.5 mm by 2.5 mm in-line pin-patterned anvil with 2.5 mm spacing between the pins. The mating horn was manufactured by Emerson Industrial Automation, Andheri, Mumbai, India. The welder was operated at a frequency of 60 hertz with a trigger force of 2 Newtons and dwell time of 2.5 seconds and with an AB relay setting of 1.25 and AB relay time 0.25 seconds. After the welding step, excess material beyond the weld was cut away. A second frame panel was formed as the first except that a malleable aluminum strip, 9 cm long by 0.5 cm wide and 1 mm thick, was inserted between the cover web and mechanical fastener prior to welding. The aluminum strip was orientated lengthwise with respect to the panel and was centered in the middle of the panel end-to-end. The center line of the aluminum strip, oriented along its length, was positioned 7 mm from the perimeter edge 36 of the panel, as depicted in FIG. 2. Additional weld points around the aluminum strip secured it in place during the welding step. The aluminum strip, welded in place in this manner, functioned as a nose clip, depicted as 35 in FIG. 2. Using the frame panels, the frame and harness assembly was constructed.

The frame and harness assembly was formed by facing and aligning the frame panels, inner web to inner web and welding the end tabs together. The harness was attached to the frame assembly at the end tabs with staples, the harness ends being fixed 10 mm from the frame ends. The rectangular profile staples were 17 gage cadmium free galvanized wire of width 1.5 mm and thickness 0.43 mm. The elasticized harness consisted of two 25 cm lengths of braided polyisoprene elastic and polyester fiber strands. The five stranded braded elastic was 5 mm wide. With the harness attached, the reusable frame and harness assembly was complete. The completed frame had a slot length of 21 cm, which could be opened to receive a replaceable filtering structure.

A replaceable filtering structure was made by first forming a filter pre-form and then assembling the filtering structure using the pre-form. The filter pre-form was made by layering together 23 cm by 24 cm web sections of spunbond nonwoven, microfiber filter media, and spunbond nonwoven. The spunbond nonwoven employed was made of polypropylene and had basis weight of 30 grams per square meter (gsm). The microfiber filter media was a 65 gsm, electret charged, polypropylene web that had an effective fiber size of 7.5 μm, produced by the method generally described in U.S. Pat. No. 4,215,682 to Kubik et al. The layered webs where ultrasonically welded at all four corners, in a circular arc pattern of 57 mm radius. Two straight lines were then welded along the length of the pre-form, 50 mm from the edges. A gothic window pattern outline was welded along the center line of the shorter edge of the per-form at a position 33 mm from the both edges. The welded layers of web were then folded into a “W” pattern along the long length of the pre-form, such that the already welded lines of demarcation were positioned at the edge of the folded form, away from the open end of the filtering structure. Each wing of the “W” pattern was made by folding the formed sheet at a location 35 mm from the center line of shorter side, along the length of the pre-form. Welding of the “W” patterned pre-form was carried out in a circular arc of 57 mm radius that was extended to the center of the folded line. The weld points had a parallelogram shape each measuring 1.5 mm wide and 2.4 mm long, with angled sides of 30 deg and 150 deg for the wide and long edges respectively. Spacing of the weld points was 1.5 mm. A continuous 0.5 mm wide weld line was made on the outer edge of the pre-form to aid in trimming and finishing. At the opening of the filter structure, 4 cm lengths of the pre-form remained unwelded. These portions of the pre-form served as flaps that could be folded back on the frame assembly to secure the filter structure to the frame of the assembled mask. The resulting welded filter structure was 22 cm wide at the front and 21 cm wide at the opening with a central folded section at the front that was 4 cm deep. The flaps on either side of the opening were 21 cm long and 1 cm wide. With the assembly of the replaceable filter structure complete the filter structure was mated to the frame to form the mask.

Construction of the finished mask entailed fitting the front, closed end, of the filter structure through the slot of the frame and harness assembly until the flap section of the filter reached the top edge of the frame slot, depicted as 38 in FIG. 3. The flaps were then folded down and secured to the microreplicated mechanical fastener surface of the frame, matting the replaceable filter to the frame.

The resulting respirator was tested for Locking Mechanical Strength, Fit Test, and Mask Reusability. Results of the test are set forth in Table 1 below.

TABLE 1

| | Locking Mechanism | Peel | FIT | FIT | FIT |
|---|---|---|---|---|---|
| | Strength | Strength | (1^{st} | (5^{th} | (15^{th} |
| Example | (kgf) | (kgf) | day) | day) | day) |
| E1 | 0.135 | 2.707 | 200 | 200 | 200 |

The data in Table 1 show that even after a number of donnings and doffings a mask of the invention still delivers protection to the wearer over the simulated usage for 5, 10 and 15 days and that the attachment between the filter structure and frame are of sufficient integrity to keep the mask intact over the usage period.

This invention may take on various modifications and alterations without departing from its spirit and scope. Accordingly, this invention is not limited to the above-described but is to be controlled by the limitations set forth in the following claims and any equivalents thereof.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

What is claimed is:

1. A flat-fold filtering face-piece respirator that comprises:
(a) a reusable harness;
(b) a replaceable filtering structure; and
(c) a reusable frame that has the reusable harness secured thereto and that comprises first and second opposing panels that define a slot into which the replaceable filtering structure can be manually inserted to be joined to the reusable frame in a removable fashion to provide a flat-folded mask body that can be opened into a cup-shaped configuration for placement over a person's nose and mouth when in use, the replaceable filtering structure also being able to be separated from the reusable frame by being manually withdrawn from the slot.

2. The flat-fold filtering face-piece respirator of claim 1, wherein the replaceable filtering structure comprises first and second flaps that can be joined to the reusable frame at first and second outer faces of first and second panels, respectively.

3. The flat-fold filtering face-piece respirator of claim 2, wherein the first and second flaps covering the first and second outer surfaces, respectively.

4. The flat-fold filtering face-piece respirator of claim 3, wherein the first and second flaps are joinable to the reusable frame at the first and second outer faces through a pressure sensitive adhesive or a mechanical fastener.

5. The flat-fold filtering face-piece respirator of claim 4, wherein the first and second flaps when joined to the reuseable frame are joined thereto at a Locking Mechanism Strength of 0.08 kgf.

6. The flat-fold filtering face-piece respirator of claim 4, wherein the first and second flaps when joined to the reuseable frame are joined thereto at a Locking Mechanism Strength of 0.1 to 2.2 kgf.

7. The flat-fold filtering face-piece respirator of claim 4, wherein the first and second flaps are joinable to the reusable frame at the first and second faces through a hook and loop mechanical fastener.

8. The flat-fold filtering face-piece respirator of claim 7, wherein the first and second flaps each comprise a nonwoven fibrous web that acts as the loop portion of the fastener, and the first and second opposing panels each comprise a hook material on an outer surface thereof.

9. The flat-fold filtering face-piece respirator of claim 8, wherein the nonwoven fibrous web is a cover web.

10. The flat-fold filtering face-piece respirator of claim 2, wherein the replaceable filtering structure is positioned within the slot in the frame such that the frame does not make contact with the wearer's face when the respirator is being worn on a person's face.

11. The flat-fold filtering face-piece respirator of claim 10, wherein the replaceable filtering structure is positioned in the slot in the frame such that the filtering structure makes contact with the wearer's face at a perimeter of the filtering structure when the respirator is in use.

12. The flat-fold filtering face-piece respirator of claim 11, wherein the perimeter is defined by folds in the first and second flaps.

13. The flat-fold filtering face-piece respirator of claim 1, wherein the replaceable filtering structure comprises one or more pleats.

14. The flat-fold filtering face-piece respirator of claim 13, wherein the replaceable filtering structure comprises a central pleat that has first and second faces that contact each other when the flat-fold filtering face-piece respirator is in the folded condition.

15. The flat-fold filtering face-piece respirator of claim 1, wherein the first and second panels comprise first and second inner surfaces that contact first and second surfaces of the filtering structure when the respirator is placed in the folded condition.

16. The flat-fold filtering face-piece respirator of claim 1, wherein the harness is secured to the frame at first and second tabs located at first and second ends of the frame.

17. The flat-fold filtering face-piece respirator of claim 1, wherein filtering structure comprises first and second flaps and a filtering portion, wherein the filtering portion comprises inner and outer cover webs and a filtering layer, and wherein the first and second flaps comprise the first and second cover webs.

18. The flat-fold filtering face-piece respirator of claim 17, wherein the filtering portion has at least one pleat.

19. A method of making a respirator, which method comprises:
inserting a replaceable filtering structure into a slot of a reusable frame; and
securing a flap of the filtering structure to an outer surface of a panel on frame.

20. The method of claim 19, wherein the flap is secured to the outer surface by folding the flap about a line and pressing the flap against the outer surface of the panel.
